(19) United States
(12) Patent Application Publication
(10) Pub. No.: US 2007/0265872 A1
(43) Pub. Date: Nov. 15, 2007

(54) Paying tolls utilizing a financial service provider and paying a subscription or license fee

(75) Inventors: Benjamin P. Robinson, Plano, TX (US); Sarath K. Balachandran, Irving, TX (US)

Correspondence Address: RG & ASSOCIATES, 1103 TWIN CREEKS, STE. 120, ALLEN, TX, 75013, US

(73) Assignee: Rent-A-Toll, Ltd., Plano, TX (US)

(21) Appl. No.: 11/640,550

(22) Filed: Dec. 18, 2006

Related U.S. Application Data
(60) Provisional application No. 60/799,229, filed on May 10, 2006.

(51) Int. Cl. G06Q 10/00; G06Q 30/00

(52) U.S. Cl. 705/1

(57) ABSTRACT

A system, method, and computer readable medium for renting a transport and for paying tolls utilizing a financial service, comprises receiving a service request for renting the transport and for paying the tolls at a card service provider, sending the service request, information related to the renting of the transport, and an identifier of a user's card to a toll rental entity, receiving toll data from a toll authority, matching the toll data with the service request based on the information related to the renting of the transport, and charging the card service provider for tolls incurred by the transport based on the matched data.

### CROSS REFERENCE TO RELATED APPLICATIONS

The present patent application claims priority from U.S. Provisional Patent Application No. 60/799,229, filed on May 10, 2006, and titled Method And System For Providing Toll Service To Credit Card Holders, the entire contents of which are incorporated by reference herein. The present patent application is also related to commonly assigned U.S. patent application Docket No. RTL030A entitled TRANSFERRING TOLL DATA FROM A THIRD PARTY OPERATED TRANSPORT TO A USER ACCOUNT, filed on even date herewith, the entire contents of which are incorporated by reference herein.

### BACKGROUND OF THE INVENTION

The present invention is generally related to toll billing and, more specifically to paying tolls utilizing a financial service.

A toll road, tollway, turnpike, pike or tollpike is a road on which a toll authority collects a fee for use. Similarly there are toll bridges and toll tunnels. Non-toll roads are financed using other sources of revenue, most typically gasoline tax or general tax funds. Tolls have been placed on roads at various times in history, often to generate funds for repayment of toll revenue bonds used to finance constructions and/or operation.

Two variations of toll roads exist: barrier (mainline) toll plazas and entry/exit tolls. On a mainline toll system, all vehicles stop at various locations on the highway to pay a toll. While this may save money from the lack of need to construct tolls at every exit, it can cause traffic congestion, and drivers can evade tolls by going around them (as the exits do not have them). With entry/exit tolls, vehicles collect a ticket when entering the highway, which displays the fares it will pay when it exits, increasing in cost for distance traveled. Upon exit, the driver will pay the amount listed for the given exit. Should the ticket indicate a traveling violation or be lost, the driver would typically pay the maximum amount possible for travel on that highway.

The term turnpike refers to the pike or long stick that was held across the road, and only raised or turned aside when the traveler paid the toll. Travelers have disliked toll roads not only for the cost of the toll, but also for the delays at tollbooths.

An adaptation of military “identification friend or foe” or RFID technology, called electronic toll collection, is lessening the delay incurred in toll collection. The electronic system determines whether a passing car is enrolled in the program, alerts enforcers if it is not. The accounts of registered cars are debited automatically without stopping or even opening a window. Other systems are based on GPRS/GSM and GPS technology. One of the advantages of GPS-based systems is their ability to adapt easily and quickly to changes in charge parameters (road classes, vehicle types, emission levels, times slots etc). Another advantage is the systems' ability to support other value-added services on the same technology platform. These services might include fleet and vehicle engine management systems, emergency response services, pay-as-you-drive insurance services and navigation capabilities.

The first major deployment of an RFID electronic toll collection system was on the Dallas North Tollway in 1989. The RFID technology used on the Dallas North Tollway was originally developed at Sandia Labs for use in tagging and tracking livestock.

Highway 407 in the province of Ontario, Canada has no tollbooths and instead, the rear license plates of all vehicles are photographed when they enter and exit the highway. A bill is mailed monthly for usage of the 407. Lower charges are levied on frequent 407 users who carry electronic transponders in their vehicles. The approach has not been without controversy: In 2002 the 407 ETR settled a class action with a refund to users.

Some systems use a small radio transponder mounted in or on a customer's vehicle to deduct toll fares from a pre-paid account as the vehicle passes through the toll barrier. This reduces manpower at tollbooths and increases traffic flow and fuel efficiency by reducing the need for complete stops to pay tolls at these locations.

By designing a tollgate specifically for electronic collection, it is possible to carry out open-road tolling, where the customer does not need to slow at all when passing through the tollgate. The state of Texas is testing a system on a stretch of Texas 121 that has no tollbooths. Drivers without a TollTag have their license plate photographed automatically and the registered owner will receive a monthly bill, at a higher rate than those vehicles with TollTags.

Electronic toll collection (ETC) systems also have drawbacks. A computer glitch can result in delays several miles long. Some state turnpike commissions have found that such a system would be ineffective because most of the people who use the turnpike are not commuters, are from states that have no ETS on turnpikes, or are from states that don't have a turnpike at all. The toll plazas of some turnpikes are antiquated because they were originally built for traffic that stops to pay the toll or get a ticket.

Currently meeting car rental agency and car rental customer needs with respect to toll billing presents difficulties. Currently car rental customers are unable to use the fast toll lanes. The only alternative available to car renters was to line up at tollbooths and wait to pay tolls. Some car renters find themselves under significant time pressure and run the booths, causing problems and expense for toll authorities and car rental agencies. As electronic toll collection technology has improved, toll authorities have begun to hold rental agencies accountable for toll violations.

Therefore, what is needed is management of toll billing. More specifically, what is needed is a method, computer readable media and system for paying tolls utilizing a financial service to allow car renters to utilize the electronic express lane.

### SUMMARY OF THE INVENTION

Toll Subscription by a Financial Service Provider (TSFSP)

Toll Subscription by a Financial Service Provider is a service that allows car renters to have billing applied to their Financial Service account while driving the rental car on the toll roads.

Rental Car Agency (RCA)

Rental car agencies are commercial entities that rent cars to corporate card holders or financial service customers.

Third Party Entity (TPE)

The third party entity is typically the rental car agency, however in some circumstances it could be a user of a rental agency vehicle or it could a fleet vehicle for a University, for a trucking company or other fleet vehicle entity.

Toll Rental Entity (TRE)

The toll rental entity is typically a provider of toll rental services to a Financial Service Provider (FSP), TPE and their users, however a TRE could be a rental car agency if the User is the third party entity. The TRE communicates toll data from a Toll Authority to a TPE after such toll data has been matched to either plurality of vehicles or Users or a single vehicle or User. The toll data which is communicated will be used for billing purposes of the TRE to the TPE or FSP. In one embodiment the TPE or RCA may choose not to bill the User for toll services, in such embodiment the TRE may send the toll data to the FSP and TPE or may not. In some circumstances the TPE may pay a licensing or subscription fee directly to the TRE and the TRE then handles all payments to the Toll Authority for such toll data accumulated by the TPE vehicles.

Toll Authority (TA)

Toll authorities are government, quasi-government or private entities that are legally authorized to collect tolls. These entities are required by law to use the collected tolls to build and maintain the roads for which the tolls are collected. Toll Authority captures toll usage from the Toll Facility or Toll Plaza and verifies if the vehicles are registered as TRE vehicle, TA charges TRE by duration or by transaction and optionally send the transaction information to the TRE or directly to the TPE or FSP. Any additional evidence or transaction information from Toll Authority can be provided to TPE and FSP on demand.

Opt-In

The Opt-In process facilitates the User or car renter to add toll service to their customer agreement. This allows the User or Card Holder to use the toll rental entity to pay the toll authority and the toll rental entity transfers the toll usage to the TPE for communication and billing to the Card Holder and/or User.

Opt-In process facilitates card holders and/or financial service customers to use high speed toll roads while driving rental or third party operated transports. TRE facilitates the communication between Card Service Providers (CSP) and/or Financial Service Providers (FSP) and TA. TRE pays TA and CSP or FSP pays TRE for the toll usage. In other embodiments the TPE may pay the TRE a license or subscription fee for all tolls accumulated by their transports which are registered with the TRE. In other embodiments, the TRE can facilitate the communication between other entities such as Application Service Providers (ASP) and the like.

Opt-Out

An Opt-Out occurs when the car renter or User chooses to rent or operate a transport without the toll subscription services.

Toll Violation and Toll Transactions

If the rental customer or a TPE chooses to opt-in for the toll subscription service then there will be no toll violations to consider because all toll transactions accrued will be billed directly to the card service provider or covered completely in the license or subscription fee paid directly to the TRE. However, if customer decides not to use the toll subscription service, and the rental agency utilizes the present invention, then that customer would then be placed into an Imposed Opt-In and the subscription or license fees associated with the vehicle will be placed onto the customers' bill or charged directly to the TPE. Toll Violations are identified by vehicle license plates via Optical Character Recognition (OCR), GPS, DSRC and RFID transponders which do not have an active account or service assigned to the recognition device.

Rental Agreement Number (RAN)

When a person rents a car, they sign a rental agreement with the third party entity, which in this case is the rental car agency. A rental agreement number uniquely identifies each rental agreement. The rental agreement number is an ideal reference to attach a car renter with the toll subscription service. The rental agreement number is a reference number used between rental car agency or TPE and the present invention for Opt-In transactions. Third party entity sends the rental agreement number to the present invention for any toll subscription service Opt-Ins.

Toll Subscription Service System Overview

In the toll subscription service, the rental license plate number, Optical Character Recognition (OCR), Radio Frequency Identification (RFID), and Onboard Unit (OBU) are used as common references between the third party entity, toll authority, and the present invention systems.

When the car renter or User chooses to Opt-In into toll subscription service or the TPE determines to subscribe all fleet transports to the toll subscription service, the TPE sends the Opt-In details to the toll authority via the present invention system in order for the TA billing of tolls to the TRE. The present invention functions as a clearinghouse to communicate appropriate information to the toll authorities. When a rental vehicle crosses a tollgate, the toll authority system captures the vehicle identification in the toll plaza via one of a multiple of identification methods. If the license plate number, transponder, RFID, or OBU are part of the present invention Opt-In database or part of the TRE vehicle database, the toll authority saves the toll usage information for the Opt-In period and updates the present invention. The TRE may match tolls against their registered fleet for payment or the TRE may match tolls against the TPE Opt-In database for payment of tolls.

Because the present invention offers the toll subscription service, using OCR, RFID, or OBU to capture the rental vehicle information the TRE will confirm that any vehicle which is captured is a toll subscription service subscriber and then charge the card service provider and/or the TPE for the tolls used. In another embodiment the TRE may have already collected a subscription or license fee prior to a rental period and thus no additional billing to the TPE is required. In such embodiment, the TRE may bill a subscription or license fee for a period and use such fees to pay the Toll Authority for any accrued toll charges by the vehicles which have subscribed for service from the TRE.

The invention can follow one of four major models, in the first model the third party entity sends the request to the card service provider and the card service provider sends the request to the toll rental entity. In the second major model the third party entity sends the service request to the toll rental entity and the card service provider sends customer information to the toll rental entity. The toll rental entity pays the toll authority for their toll usage and the toll rental entity collects payment from the card service provider. In the third major model, the User or Card Holder sends the service request to the toll rental entity and sends request to the card service provider for subscription service. In this model, the User or Card Holder will send customer information and service information to the TRE periodically. In the fourth major model, license model, TPE sends all their fleets to the TRE and all the TRE vehicles are eligible for the toll service with the fixed monthly license fee. In this model the TRE pays TA for all the toll usage to the TA and collects a daily, weekly, or monthly licensing fee for each vehicle in the local or regional or nationwide fleet.

The following defines major stages in the toll subscription service life cycle. Third party entity sends toll subscription service Opt-In request to the present invention. Car renter rents vehicle and chooses to Opt-in to the toll subscription service. Third party entity notifies the TRE of a service request and that the customer has chosen the toll account subscription service. A unique ID will be assigned by the TRE for the specific customer and send such subscription information and request to the Toll Authority.

The present invention may update toll subscription service request to the toll authority. The present invention may notify either the third party entity or the toll authority of the Opt-In service request with vehicle information, start date, expected end date and any other required information and receive toll usage from the toll authority for the Opt-In. The present invention receives toll usage data from the toll authority, log the transactions and update the status to “IN USE”.

When the car renter returns the vehicle to the third party entity, the third party entity notifies the present invention with the end transaction. At the conclusion of the rental period the present invention may pass the end date to the toll authority to inform that the account for the rental car should be closed.

Toll Subscription Service Benefits

The toll account subscription has many benefits extending to the toll authority, third party entity, car renter, local drivers and other interested parties. Some of the benefits of toll account assignment include:

eliminating car renter toll violations for rental car agencies that offer the toll subscription service;

eliminating toll violation collection efforts by rental car agencies that offer the toll subscription service;

generating substantial new revenues for rental car agencies and eliminates operational expenses typically spent on tracking down violators; and

improving car renter travel experience within toll systems.

Rental Agency Setup

In the subscription model, each card service provider will have an account for billing card service customers for the toll service. Card Service provider sends the user account information periodically to the Toll Rental Entity to maintain the account status. When the Toll Rental Entity receives the service request and matches the toll usage, the TRE will bill the card service provider for the actual tolls and transfer the toll usage information to the CSP.

In the license model, each third party entity will have an account containing information pertaining to rental vehicles. This information is necessary due to the movement of rental vehicles between geographical locations; the present invention requires portions of the complete rental agency fleet to be registered to provide consistent subscription service. If TPE signs up for toll subscription service then by default all the vehicles registered by the TPE will be enrolled in the TRE fleet database. When the present invention moves to a new market, the third party entity can offer car renters toll subscription service for that location without any significant change. The TRE will provide the list of registered vehicles to any participating TA for billing the TRE directly for toll usage. In another embodiment the CSP or FSP may provide a list of registered vehicles or Users or Card Holders for the toll subscription service directly to the TRE. In another embodiment the User or Card Holder may provide a vehicle or list of vehicles for registration for the toll subscription service directly to the TRE.

The rental vehicle information is periodically synchronized between the toll subscription system and TPE application. This synchronization may occur nightly using the web service interface or FTP service. Whenever vehicles are added or removed from the fleet, information is sent from TPE or the CSP or FSP to the present invention system. This is the vehicle status update and is initiated by the TPE, CSP or FSP. Information exchanged between TPE and toll subscription services application is completed using XML or FTP file transfer, or may be communicated orally by the User to the TRE.

Opt-In Transactions

If the car renter is interested in using the toll subscription service, the customer agrees to using their existing toll subscription account or their CSP or FSP account to pay the toll fees for their rental period. This allows the renter to use high-speed toll lanes during the rental period. The renter does not need to stop or pay any toll fees at the tollgate. Opt-In transactions are the transactions that are made by the car renter or User with toll subscription service. The car renter or User will pay a service fee for the subscription period and may pay tolls for any toll usage during the rental period.

Begin Opt-In

When the TPE rents the vehicle to the car renter or User, the TPE will offer the toll subscription Opt-In service to the customer so the customer can use the toll roads for the given period in the rental agreement number or for a period longer than the rental agreement that corresponds to a subscription period. The TPE, CSP, FSP or the TRE will notify the present invention to begin the transaction for the rental period using web service request or other communication protocols.

The following documents the third party entity setup to use the toll subscription service provided by the present invention.

The third party entity begins rental process. The third party entity asks rental customer if they have an existing toll subscription account. The third party entity sends rental customer details to the present invention to set up rental customer for a service period. At this point third party entity must collect rental customer information to include but not limited to: rental customers' license plate number, last name, billing address, drivers' license number, and transfers that information to the present invention. The present invention verifies that the rental customer has a valid toll subscription account and the toll authority verifies that the rental customer's toll subscription account is valid. The toll authority then sends that information to the present invention.

The present invention receives this notice from toll authority. The present invention denies the toll subscription service if the rental customer or TPE does not have a valid subscription account with the TRE or toll authority. The TPE sends rental customer's Opt-In details to the present invention. The toll authority or TRE verifies that the rental customer has a valid toll subscription account and sends that information to the present invention. The present invention receives this confirmation of valid account from the toll authority or TRE. At this point the present invention creates a confirmation message and sends it to the TPE, CSP, FSP, or Card Hold or User. The TPE sets up rental customer for toll subscription Opt-In service. The TPE sends the rental agreement number, the start and end time, the toll subscription account information and the rental vehicle information to the present invention. The present invention receives this information from third party entity and transfer toll subscription account Opt-In details to toll authority. The toll authority receives the toll subscription account Opt-In details from the present invention.

The following elaborates on how third party entity, the present invention, and toll authority interact to ensure proper toll account assignment Opt-In set up occurs.

The TPE begins toll account assignment setup. The TPE asks rental customer or User if they have a valid toll subscription account and if not, the third party entity offers the customer the present invention.

The TPE begins toll subscription service setup. The TPE asks rental customer if they have a valid toll subscription account. Rental customer agrees that they do have a valid toll subscription account. At this point TPE may send rental customer personal information to the present invention. The required information that the present invention will need is, but is not limited to, rental customers' vehicle info, such as rental customers' license plate number, last name, billing address, driver's license number, and transfers that information to the present invention. The present invention takes this information and verifies that this rental customer has a toll subscription account that is valid. The toll authority or TRE confirms that this rental customer's toll subscription account is valid. The toll authority sends that information back to the present invention. The TPE offers the present invention to rental customer if there is no valid subscription account. The TPE then sends the required details back to the present invention.

The present invention system assigns a toll subscription Opt-In transaction number for reference. If the customer wants to cancel the toll subscription Opt-In request, the TPE can use toll subscription Opt-In transaction number to cancel the service.

Billing

The present invention allows the Toll Rental Entity multiple different billing durations and options. The available billing durations are: per hour, per day, per week, and per month.

The following actions are taken by the TRE, the TPE and the present invention, to ensure proper billing procedures. The TRE begins invoice process for closed Opt-Ins. The third party entity sends closed Opt-In information to the present invention. The present invention then applies service charge to reflect the duration of the toll subscription Opt-In account and an End Invoice is sent. In another embodiment the TRE will bill the TPE hourly, daily, weekly, monthly, annually, and any other combination of such periods for subscription toll services. In such embodiments the subscription or License fee may include the cost of all tolls in the fee. In such embodiment the TRE will pay all incurred tolls to the TA for any vehicles which are registered with the TRE by the TPE. In this embodiment the TRE will not send any additional toll usage fees to the TPE for subsequent billing to the User or Card Holder.

The following is the third party entity and the present invention billing process. An invoice is produced to list all the Closed Opt-In's that have not been invoiced. The present invention provides the duration of the rental so appropriate fees can be allocated. The present invention receives the closed Opt-In duration information and applies appropriate charges and end invoice. The actions taken by the present invention to ensure proper billing procedures take place for Open Opt-In tickets over certain duration of time. The present invention begins invoice process for open Opt-In's that have been open for certain duration of time. The present invention lists all open toll subscription Opt-In's that have not been invoiced. The present invention applies toll subscription service charges and any accrued tolls to open Opt-In's and End Invoice is sent. In another embodiment the present invention may produce a periodic bill directly to the TPE for a subscription service fee or license fee. In such embodiment no additional tolls will be billed for Opt-Ins. In this embodiment the TRE would be responsible for paying all toll usage for the TPE vehicle list to the Toll Authority.

The following is the present invention billing process takes place for open Opt-In tickets for a certain period of time. The present invention invoices are produced for all Open Opt-Ins that have not been invoiced. The present invention applies appropriate toll account assignment service charges to Open Opt-ins and end invoice.

Vehicle Information

The following are the vehicle properties that are used for the toll account assignment registration:

Drivers License Number;

License Plate Number;

License Type;

Vehicle Identification Number;

Make;

Model;

Year;

State/Province of Registration; and

Vehicle Class.

Opt-In Request Message

The following information is expected to be sent from the third party entity to the present invention for Opt-In service using web service request, when the rented vehicle leaves the parking location or when a vehicle is rented from the third party entity facility. Multiple Opt-In requests can be grouped into one single request for processing to the present invention. Header information will help to group multiple Opt-In.

Opt-In Details

Request Mode

Unique ID provided by the present invention to the rental agency for rental agency identification

Allowed Values {“B”, “E”}

B->Begin Opt-In

E->End Opt-In, will trigger billing

R->Vehicle Renewal

C->Cancel Opt-In

Rental Agency Opt-In ID

Customer Toll Account

The customer toll account information is collected and matched with information such as a rental agreement number and a service request.

Batch Id/transaction identification number is generated by the third party entity for tracking purpose:

Rental Agreement Number;

Service Start Date;

Service End Date; this value will be over written if the renter returns earlier than the original end date or if the renter renews his/her rental period. If the Opt-In request is open and the system date is greater than one day of original end date, if there is no end transaction and the Opt-In expired, the present invention will close the pending transaction.

If the request mode is “R”, Service End Date will have new end date which should be greater than the original service end date;

License Number of toll authority account;

License Plate Number of the rental customers' personal vehicle that the toll authority account is registered to;

License Number;

Vehicle State;

Rental Vehicle ID;

Rental Location;

Renewal date, if the request mode is “R”, renewal date should be sent to the present invention;

Cancel date; if the request mode is “C”, cancel date should be sent to the present invention; and

Return date.

In one embodiment of the present invention, a method for renting a transport and for paying tolls utilizing a financial service comprises, receiving a service request for renting the transport and for paying the tolls at a card service provider, sending the service request, information related to the renting of the transport, and an identifier of a user's account to a toll rental entity, receiving toll data from a toll authority, matching the toll data with the service request based on information related to the renting of the transport at the toll rental entity, and charging the card service provider for tolls incurred by the transport based on the matched data. The method may also comprise charging the card service provider for fees related to the tolls incurred by the transport based on the matched data, receiving fees from the card service provider at the toll rental entity and transferring the toll data to the card service provider for tolls incurred by the transport based on the matched data. The method may additionally comprise sending the service request to the card service provider, storing the service request by the card service provider, storing the service request by the toll rental entity, charging the user's card for the tolls incurred by the transport and charging the toll rental entity for the tolls incurred by the transport.

In another embodiment of the present invention, a computer readable medium comprises instructions for receiving a service request and information related to a card service provider by a toll rental entity, receiving toll data by the toll rental entity from a toll authority, matching the toll data with the service request, and charging the card service provider for the matched toll data. The computer readable medium may comprise instructions for storing the service request by the toll rental entity, storing the toll data by the toll rental entity, charging a user's card for toll usage based on the toll data and subscribing for the service request. The computer readable medium may additionally comprise instructions for activating the service request by the card service provider for a customer, storing the service request by the card service provider and paying the toll authority by the toll rental entity for the matched toll data.

In a further embodiment of the present invention, a system of renting a transport and for paying tolls utilizing a financial service, comprises a memory, and a processor communicably coupled to the memory, wherein the processor: receives a service request and card service provider data, receives toll data, matches the toll data to the service request associated with the card service provider data, and charges a card service provider for the matched toll data. The system processor may also charge a user's card for the matched toll data, and receive a customer subscription for the service request.

### BRIEF DESCRIPTION OF THE DRAWINGS

FIG. 1 illustrates a flow chart of a first model of paying tolls utilizing a financial service that includes an embodiment of the present invention;

FIG. 2 illustrates a flow chart of a second model of paying tolls utilizing a financial service that includes an embodiment of the present invention;

FIG. 3 illustrates a flow chart of a third model of paying tolls utilizing a financial service that includes an embodiment of the present invention;

FIG. 4 illustrates a diagram of a first model of paying tolls utilizing a financial service that includes an embodiment of the present invention;

FIG. 5 illustrates a diagram of a second model of paying tolls utilizing a financial service that includes an embodiment of the present invention;

FIG. 6 illustrates a diagram of a third model of paying tolls utilizing a financial service that includes an embodiment of the present invention;

FIG. 7 illustrates a subscription process of paying tolls utilizing a financial service that includes an embodiment of the present invention;

FIG. 8 illustrates a toll account system of paying tolls utilizing a financial service in accordance with an embodiment of the present invention;

FIG. 9 illustrates a flow chart of a fourth model of paying tolls utilizing a financial service that includes an embodiment of the present invention; and

FIG. 10 illustrates a license plate request model of paying tolls utilizing a financial service in accordance with an embodiment of the present invention.

### DETAILED DESCRIPTION OF THE INVENTION

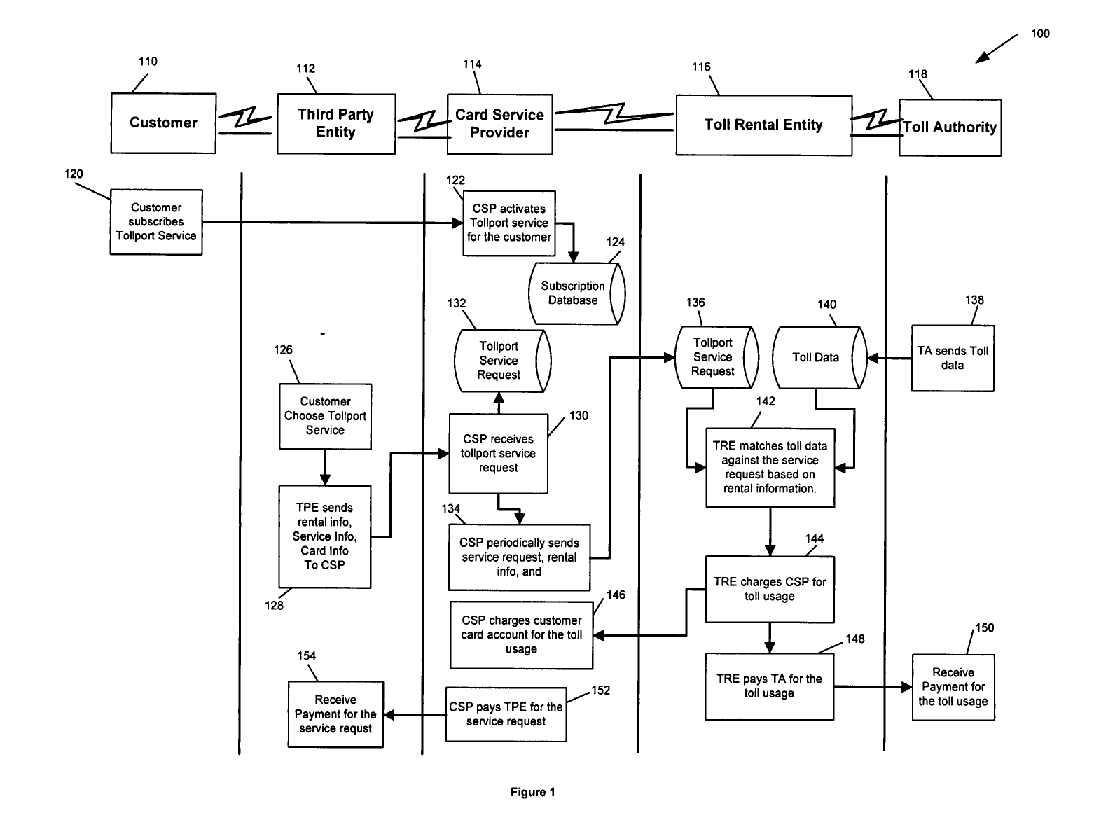

Referring now to FIG. 1, a flow chart of a first model of paying tolls utilizing a financial service 100 is depicted. Five entities are in communication, a customer 110, a third party entity 112, a card service provider 114, a toll rental entity 116 and a toll authority 118. The third party entity is typically a rental car agency but may be an individual. The toll rental entity is typically a service provider, however it could be a rental car agency if the user is the third party entity. The toll authority is a government, quasi-government or private entity that is legally authorized to collect tolls. The customer subscribes 120 to the toll transfer service, which may be referred to as the Tollport service. The card service provider activates 122 the toll transfer service for the customer and the information is stored 124 in a subscription database.

The customer chooses 126 the toll transfer service and the third party entity sends 128 the rental information, service request information and card service information to the card service provider. The card service provider receives 130 the service request and stores 132 the request. The card service provider periodically sends 134 the service request and rental information to the toll rental entity. The toll rental entity stores 136 the service request. The toll authority sends 138 toll usage data to the toll rental entity which stores 142 the toll data. The toll rental entity matches 142 the stored service requests to the stored toll data based on the rental information. The toll rental entity bills 144 the card service provider for the matched toll usage and which point the card service provider bills 146 the customer card account for the toll usage. The toll rental entity pays 148 the toll authority for the matched toll usage and the toll authority receives 150 the payment for the matched toll usage. The card service provider pays 152 the third party entity for the service request and the third party entity receives payment 154 for the service request. The transfer of information occurs via at least one of: a wireless protocol, a wired protocol and a combination of the wireless protocol and the wired protocol. The steps in the flow are performed by software, hardware, firmware, and/or the combination of software, hardware, and/or firmware.

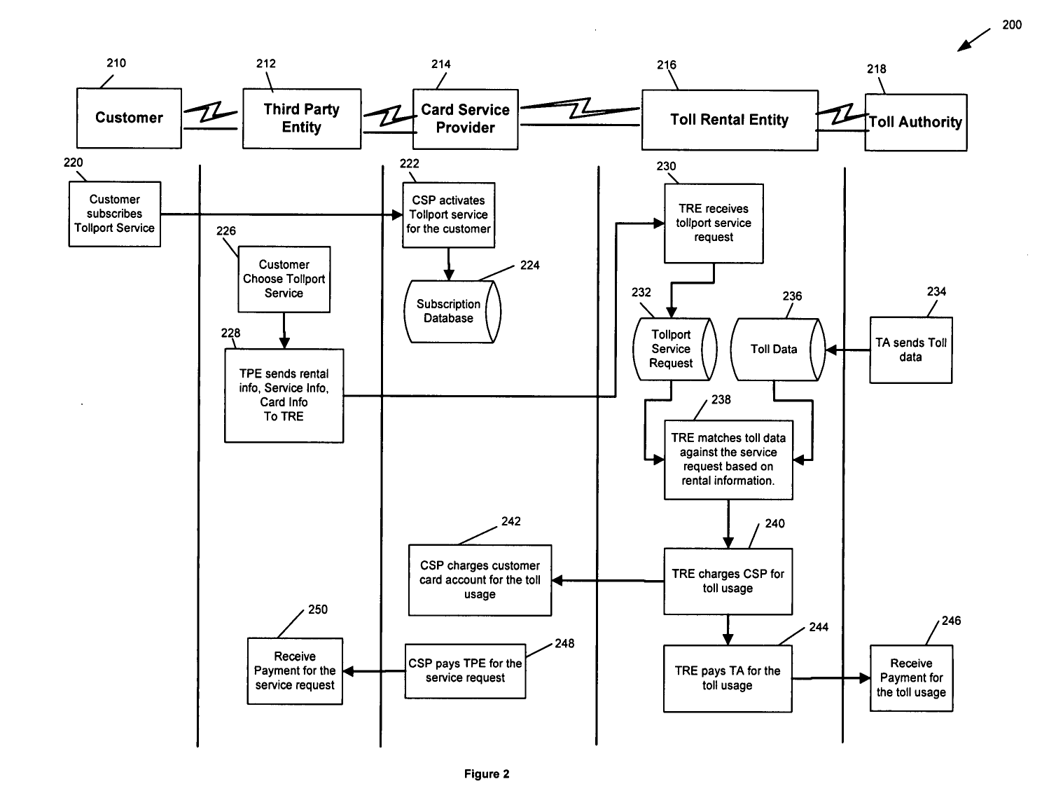

Referring now to FIG. 2, a flow chart of a second model of paying tolls utilizing a financial service 200 is depicted. Five entities are in communication, a customer 210, a third party entity 212, a card service provider 214, a toll rental entity 216 and a toll authority 218. The third party entity is typically a rental car agency but may be an individual. The toll rental entity is typically a service provider, however it could be a rental car agency if the user is the third party entity. The toll authority is a government, quasi-government or private entity that is legally authorized to collect tolls. The customer subscribes 220 to the toll transfer service, which may be referred to as the Tollport service. The card service provider activates 222 the toll transfer service for the customer and the information is stored 224 in a subscription database.

The customer chooses 226 the toll transfer service and the third party entity sends 228 the rental information, service request information and card service information to the toll rental entity. The toll rental entity stores 232 the service request. The toll authority sends 234 toll usage data to the toll rental entity, which stores 236, the toll data. The toll rental entity matches 238 the stored service requests to the stored toll data based on the rental information. The toll rental entity bills 240 the card service provider for the matched toll usage and which point the card service provider bills 242 the customer card account for the toll usage. The toll rental entity pays 244 the toll authority for the matched toll usage and the toll authority receives 246 the payment for the matched toll usage. The card service provider pays 248 the third party entity for the service request and the third party entity receives payment 250 for the service request. The transfer of information occurs via at least one of: a wireless protocol, a wired protocol and a combination of the wireless protocol and the wired protocol. The steps in the flow are performed by software, hardware, firmware, and/or the combination of software, hardware, and/or firmware.

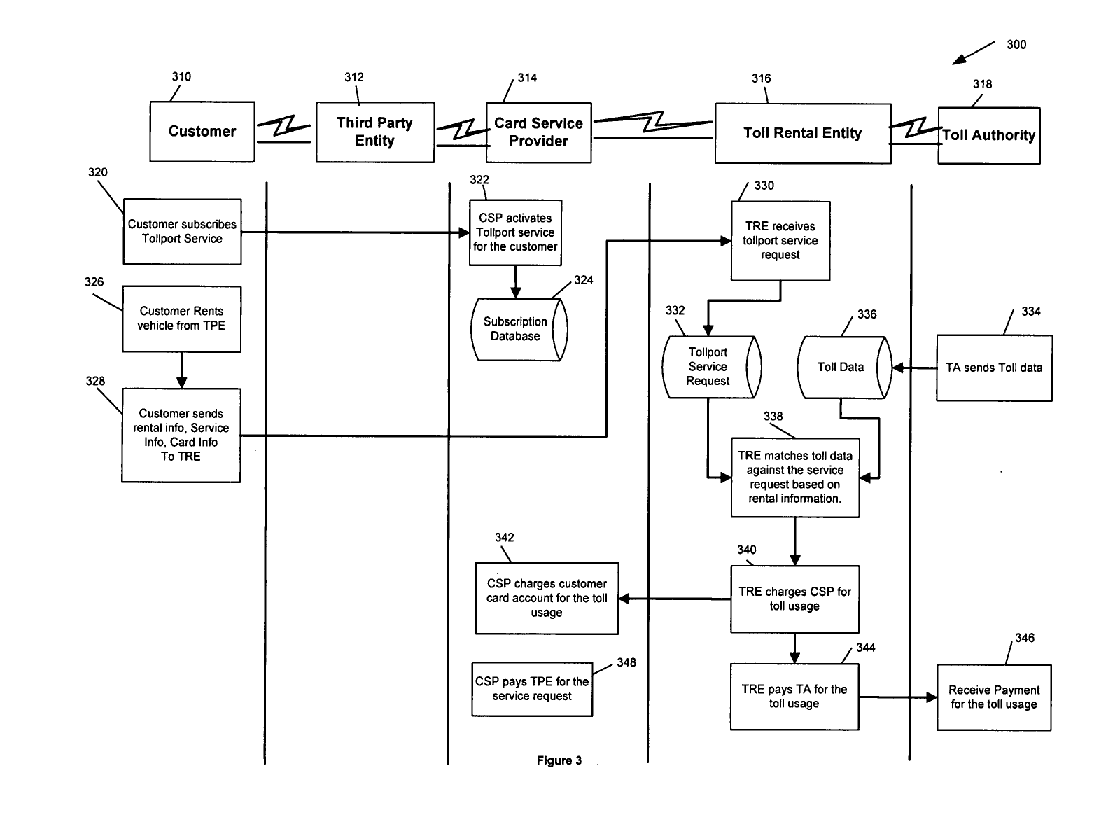

Referring now to FIG. 3, a flow chart of a third model of paying tolls utilizing a financial service 300 is depicted. Five entities are in communication, a customer 310, a third party entity 312, a card service provider 314, a toll rental entity 316 and a toll authority 318. The third party entity is typically a rental car agency but may be an individual. The toll rental entity is typically a service provider, however it could be a rental car agency if the user is the third party entity. The toll authority is a government, quasi-government or private entity that is legally authorized to collect tolls. The customer subscribes 320 to the toll transfer service, which may be referred to as the Tollport service. The card service provider activates 322 the toll transfer service for the customer and the information is stored 324 in a subscription database.

The customer rents 326 a vehicle from the third party entity that sends 328 the rental information, service request information and card service information to the toll rental entity. The toll rental entity receives 330 the service request and stores 332 the service request. The toll authority sends 334 toll usage data to the toll rental entity, which stores 336, the toll data. The toll rental entity matches 338 the stored service requests to the stored toll data based on the rental information. The toll rental entity bills 340 the card service provider for the matched toll usage and which point the card service provider bills 342 the customer card account for the toll usage. The toll rental entity pays 344 the toll authority for the matched toll usage and the toll authority receives 346 the payment for the matched toll usage. The card service provider pays 348 for the service request. The transfer of information occurs via at least one of: a wireless protocol, a wired protocol and a combination of the wireless protocol and the wired protocol. The steps in the flow are performed by software, hardware, firmware, and/or the combination of software, hardware, and/or firmware.

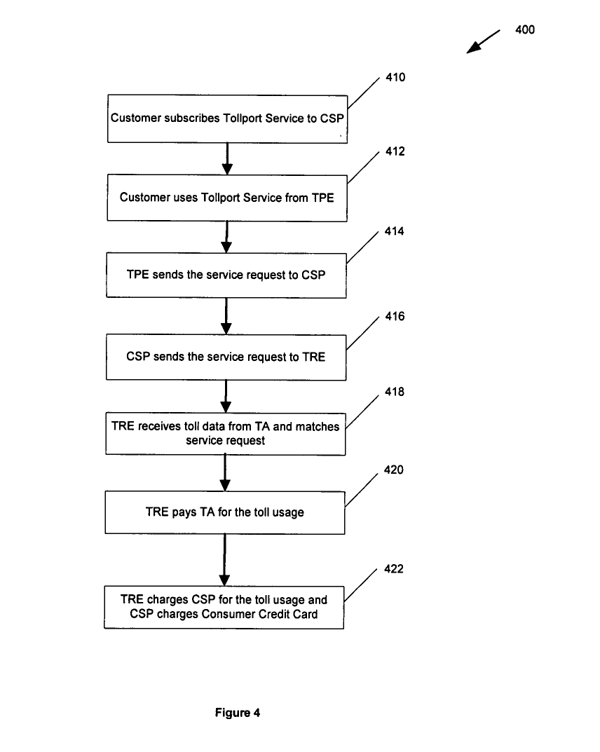

Referring now to FIG. 4, a diagram of a first model of paying tolls utilizing a financial service 400 is depicted and comprises a number of blocks or modules that are software, hardware, or firmware, and/or the combination of software, hardware, and/or firmware. The customer subscribes 410 to the toll transfer service utilizing the card service provider. The customer utilizes 412 the toll transfer service from the third party entity. The third party entity sends 414 the service request to the card service provider. The card service provider sends 416 the service request to the toll rental entity. The toll rental entity receives 418 toll data from the toll authority. The toll rental entity pays 420 the toll authority for the toll usage. The toll rental entity charges 422 the card service provider for the toll usage and the card service provider charges the customer credit card. The transfer of information occurs via at least one of a wireless protocol, a wired protocol and the combination of the wireless protocol and the wired protocol.

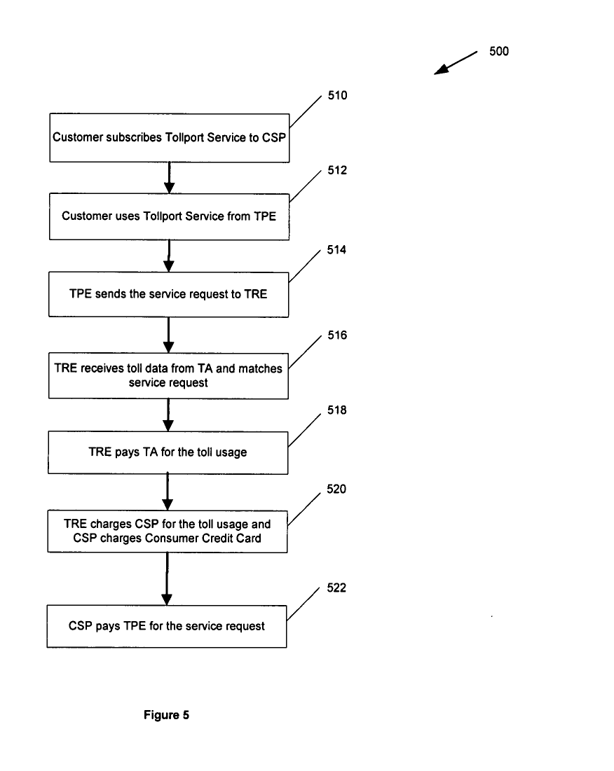

Referring now to FIG. 5, a diagram of a second model of paying tolls utilizing a financial service 500 is depicted and comprises a number of blocks or modules that are software, hardware, or firmware, and/or the combination of software, hardware, and/or firmware. The customer subscribes 510 to the toll transfer service utilizing the card service provider. The customer utilizes 512 the toll transfer service from the third party entity. The third party entity sends 514 the service request to the toll rental entity. The toll rental entity receives 516 toll data from the toll authority and matches the received data to the service request. The toll rental entity pays 518 the toll authority for the toll usage. The toll rental entity charges 520 the card service provider for the toll usage and the card service provider charges the customer credit card. The card service provider pays 522 the third party entity for the service request. The transfer of information occurs via at least one of a wireless protocol, a wired protocol and the combination of the wireless protocol and the wired protocol.

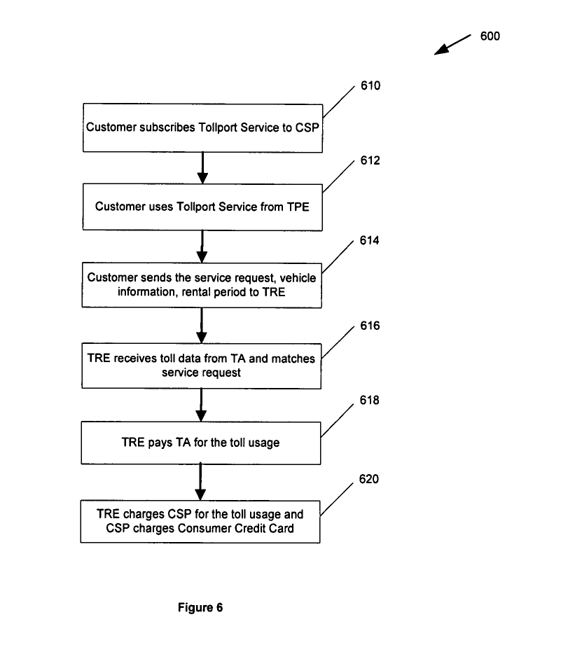

Referring now to FIG. 6, a diagram of a third model of paying tolls utilizing a financial service 600 is depicted and comprises a number of blocks or modules that are software, hardware, or firmware, and/or the combination of software, hardware, and/or firmware. The customer subscribes 610 to the toll transfer service utilizing the card service provider. The customer utilizes 612 the toll transfer service from the third party entity. The customer sends 614 the service request, the vehicle information and the rental period to the toll rental entity. The toll rental entity receives 616 toll data from the toll authority and matches the received data to the service request. The toll rental entity pays 618 the toll authority for the toll usage. The toll rental entity charges 620 the card service provider for the toll usage and the card service provider charges the customer credit card. The transfer of information occurs via at least one of a wireless protocol, a wired protocol and the combination of the wireless protocol and the wired protocol.

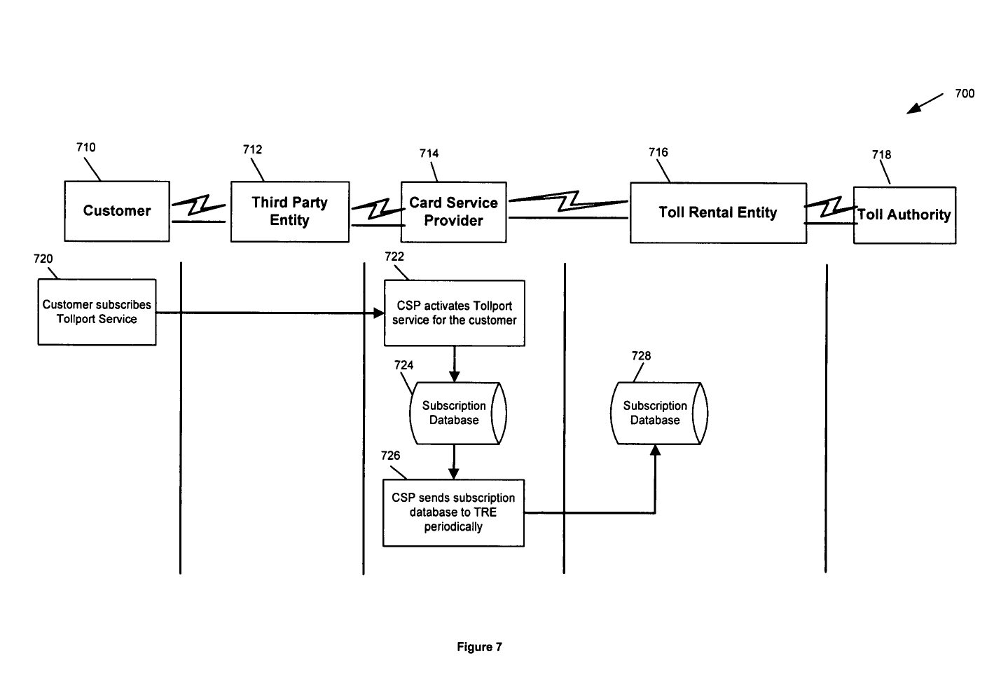

Referring now to FIG. 7, a subscription process of paying tolls utilizing a financial service 700 is depicted. Five entities are in communication, a customer 710, a third party entity 712, a card service provider 714, a toll rental entity 716 and a toll authority 718. The third party entity is typically a rental car agency but may be an individual. The toll rental entity is typically a service provider, however it could be a rental car agency if the user is the third party entity. The toll authority is a government, quasi-government or private entity that is legally authorized to collect tolls. The customer subscribes 720 to the toll transfer service. The card service provider activates 722 the toll transfer service for the customer and stores 724 the subscription information. The card service provider periodically sends 726 the subscription information to the toll rental entity where it is stored 728 by the toll rental entity. The transfer of information occurs via at least one of a wireless protocol, a wired protocol and the combination of the wireless protocol and the wired protocol.

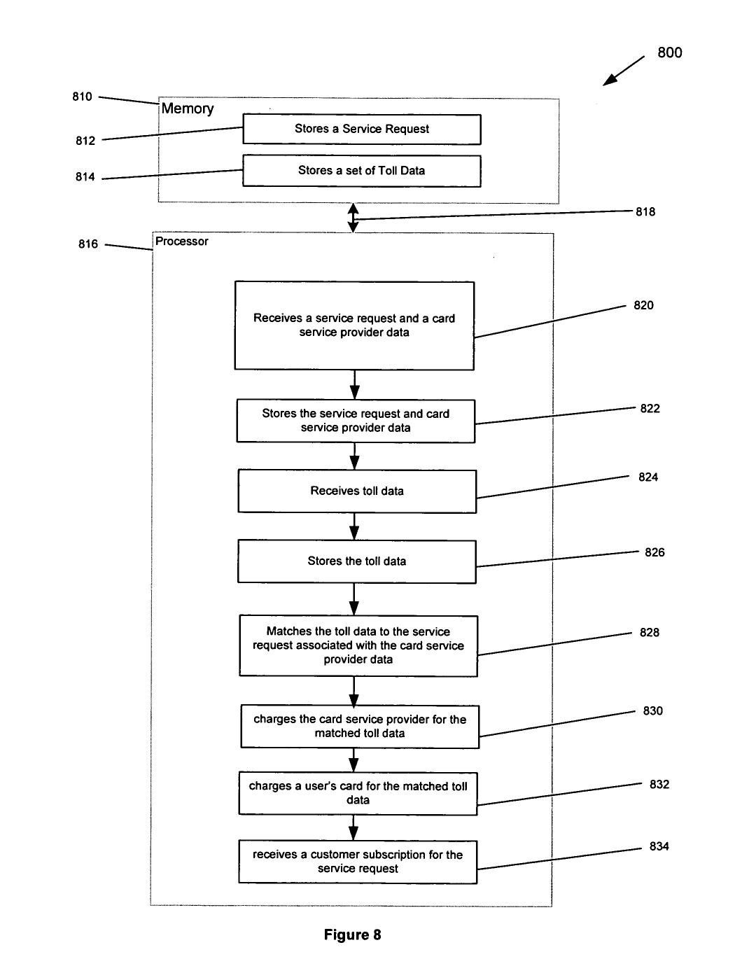

Referring now to FIG. 8, a system of toll account system of paying tolls utilizing a financial service 800 is depicted. The system comprises, a memory 810 that receives a service request 812 and a toll data 814, and a processor 816 communicably coupled 818 to the memory, wherein the processor, receives 820 a service request and a card service provider data, stores 822 the service request and card service provider data, receives 824 toll data, stores 826 the toll data, matches 828 the toll data to the service request associated with the card service provider data, and charges 830 the card service provider for the matched toll data. The system processor may also charge 832 a user's card for the matched toll data, and receive 834 a customer subscription for the service request. The transfer of information between the processor and the memory occurs via at least one of a wireless protocol, a wired protocol and a combination of a wireless protocol and a wired protocol. The steps performed in this figure are performed by software, hardware, firmware, and/or the combination of software, hardware, and/or firmware. Additionally, the processor and/or memory described herein form a circuit.

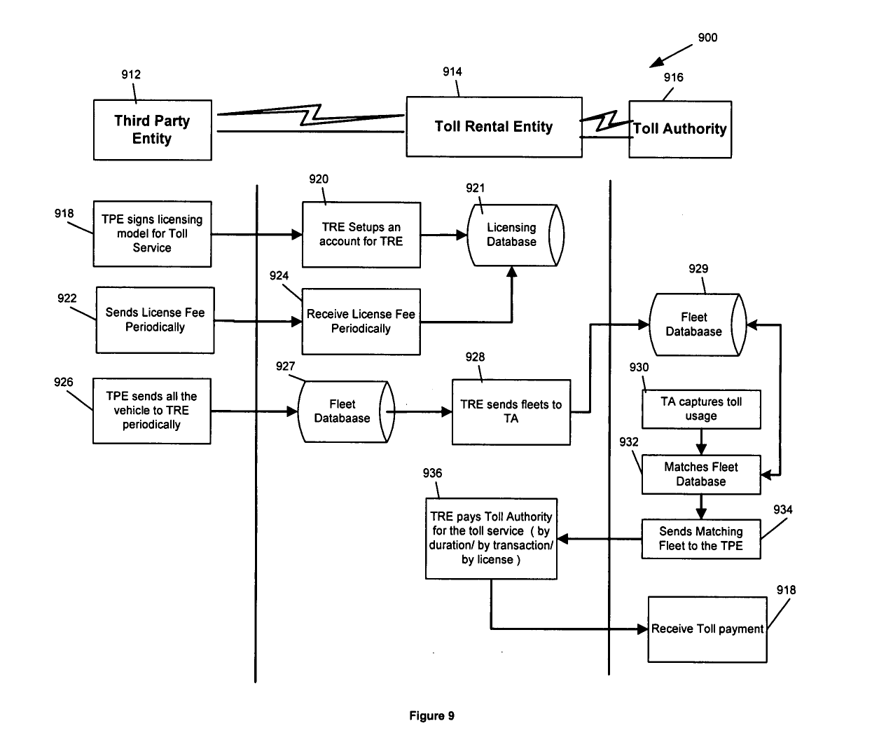

Referring now to FIG. 9, a flow chart of a fourth model of paying tolls utilizing a financial service 900 is depicted. Three entities are in communication, a third party entity 912, a toll rental entity 914 and a toll authority 916. The third party entity is typically a rental car agency but may be an individual. The toll rental entity is typically a service provider, however it could be a rental car agency if the user is the third party entity. The toll authority is a government, quasi-government or private entity that is legally authorized to collect tolls. The third party entity signs 918 a licensing model for toll service the TRE sets up 920 an account for the TRE and stores 921 the account information in a licensing database. The third party entity sends 922 a licensing fee periodically which is received 924 by the TRE and sent to the licensing database. The third party entity periodically sends 926 all the fleet details to the TRE, which is stored 927 in a fleet database, the fleet details and change information is sent 928 from the TRE to be stored 929 in a fleet database at the toll authority. The toll authority captures 930 toll usage, matches 932 the captured data to the fleet database and sends 934 the matching fleet data to the TPE. The TPE pays 936 the toll authority for the toll service, by duration, transaction and license and the toll authority receives 918 the toll payment. The transfer of information occurs via at least one of: a wireless protocol, a wired protocol and a combination of the wireless protocol and the wired protocol. The steps in the flow are performed by software, hardware, firmware, and/or the combination of software, hardware, and/or firmware.

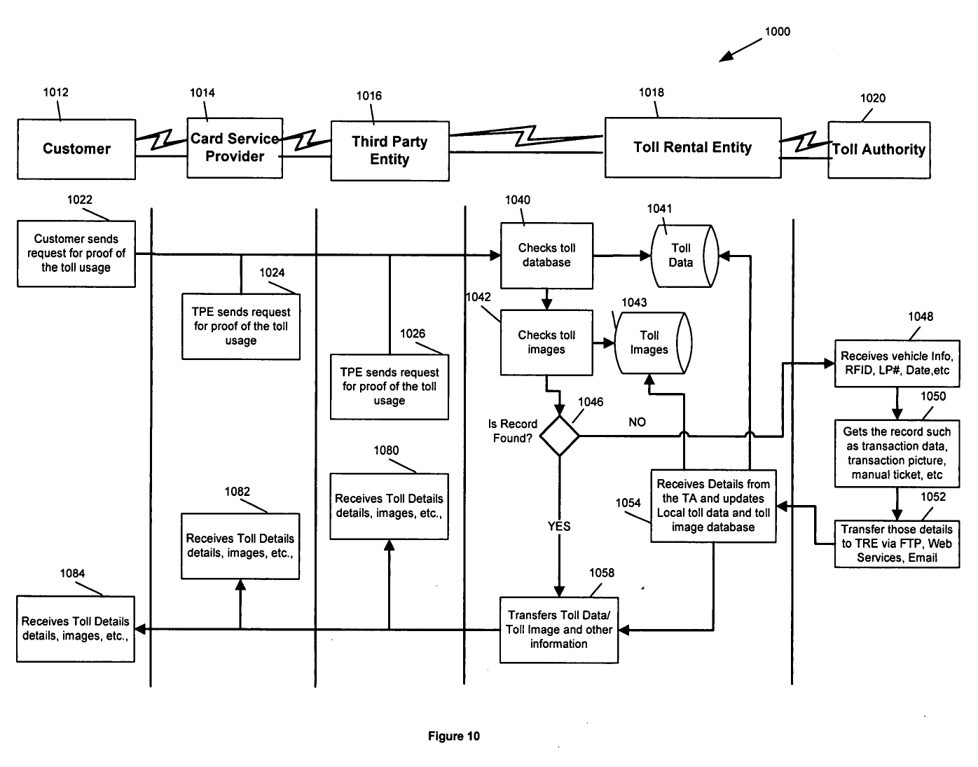

Referring now to FIG. 10, a flow chart of a request license plate model of paying tolls utilizing a financial service 1000 is depicted. Five entities are in communication, a customer 1010, a third party entity 1012, a card service provider 1014, a toll rental entity 1016 and a toll authority 1018. The third party entity is typically a rental car agency but may be an individual. The toll rental entity is typically a service provider; however it could be a rental car agency if the user is the third party entity. The toll authority is a government, quasi-government or private entity that is legally authorized to collect tolls. The customer sends 1022 a request for proof of toll usage, the card service provider sends 1024 the request for proof of toll usage, the TPE sends 1026 this request for proof of toll usage and the toll rental entity checks 1040 the toll database and stores 1041 the toll data. The toll rental entity checks 1042 the toll images and stores 1043 those images. A query 1046 is made to find the record, if it is not found the toll authority receives 1048 the vehicle information via RFID, license plate number, date, gets 1050 the record for the transaction data such as the transaction data, transaction ticket or manual ticket, and that information is transferred 1052 to the TRE via FTP, web services or email. The toll rental entity receives 1054 details from the TA and updates local toll data and toll images database. The toll data and images are transferred 1058 with other information from the TRE. The TPE receives 1080 toll details and images, the card service provider receives 1082 the toll details and images and the customer receives 1084 the toll details and images. The transfer of information occurs via at least one of: a wireless protocol, a wired protocol and a combination of the wireless protocol and the wired protocol. The steps in the flow are performed by software, hardware, firmware, and/or the combination of software, hardware, and/or firmware.

Although an exemplary embodiment of the system of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A method for renting a transport and for paying tolls utilizing a financial service, comprising:
receiving a service request for renting the transport and for paying the tolls at a card service provider;
sending the service request, information related to the renting of the transport, and an identifier of a user's card to a toll rental entity;
receiving toll data from a toll authority;
matching the toll data with the service request based on the information related to the renting of the transport; and
charging the card service provider for tolls incurred by the transport based on the matched data.

2. The method of claim 1 comprising charging the card service provider for fees related to the tolls incurred by the transport based on the matched data.

3. The method of claim 1 comprising receiving fees from the card service provider at the toll rental entity.

4. The method of claim 3 comprising transferring the toll data to the card service provider for tolls incurred by the transport based on the matched data.

5. The method of claim 1 comprising sending the service request to the card service provider.

6. The method of claim 1 comprising storing the service request by the card service provider.

7. The method of claim 1 comprising storing the service request by the toll rental entity.

8. The method of claim 1 comprising charging the user's card for the tolls incurred by the transport.

9. The method of claim 1 comprising charging the toll rental entity for the tolls incurred by the transport.

10. A computer readable medium comprising instructions for:
receiving a service request and information related to a card service provider by a toll rental entity;
receiving toll data by the toll rental entity from a toll authority;
matching the toll data with the service request; and
charging the card service provider for the matched toll data.

11. The computer readable medium of claim 10 comprising instructions for:
storing the service request by the toll rental entity.

12. The computer readable medium of claim 10 comprising instructions for:
storing the toll data by the toll rental entity.

13. The computer readable medium of claim 10 comprising instructions for:
charging a user's card for toll usage based on the toll data.

14. The computer readable medium of claim 10 comprising instructions for:
subscribing for the service request.

15. The computer readable medium of claim 14 comprising instructions for:
activating the service request by the card service provider for a customer.

16. The computer readable medium of claim 10 comprising instructions for:
storing the service request by the card service provider.

17. The computer readable medium of claim 10 comprising instructions for:
paying the toll authority by the toll rental entity for the matched toll data.

18. A system of renting a transport and for paying tolls utilizing a financial service, comprising:
a memory; and
a processor communicably coupled to the memory, wherein the processor:
receives a service request and card service provider data;
receives toll data;
matches the toll data to the service request associated with the card service provider data; and
charges a card service provider for the matched toll data.

19. The system of claim 18 wherein the processor:
charges a user's card for the matched toll data.

20. The system of claim 18 wherein the processor:
receives a customer subscription for the service request.
